(19) United States
(12) Patent Application Publication
(10) Pub. No.: US 2015/0297920 A1
(43) Pub. Date: Oct. 22, 2015

(54) AIR BLOWER AND PROTECTIVE SUIT INCLUDING THE SAME

(71) Applicant: KOKEN LTD., Chiyoda-ku, Tokyo (JP)

(72) Inventors: Hironobu TAKEUCHI, Chiyoda-ku, Tokyo (JP); Masataka KAWAZOE, Chiyoda-ku, Tokyo (JP); Yu OSHIKUBO, Chiyoda-ku, Tokyo (JP)

(73) Assignee: KOKEN LTD.

(21) Appl. No.: 14/647,127

(22) PCT Filed: Nov. 12, 2013
(86) PCT No.: PCT/JP2013/080602

§ 371 Date: May 26, 2015

(30) Foreign Application Priority Data
Nov. 30, 2012 (JP) 2012-263430

(51) Int. Cl. A62B 18/00; A62B 23/02; A62B 18/08; A62B 7/10; A62B 17/00

(52) U.S. Cl. CPC A62B 18/006; A62B 7/10; A62B 17/006; A62B 18/084; A62B 23/02

(57) ABSTRACT

Provided are an air blower and a protective suit that includes the air blower, which eliminates an air hose that connects the air blower to the protective suit without the air hose getting caught on a protrusion in a work area, which provides favorable workability. With respect to an air blower for a protective suit, the air blower configured to include an air blowing part that includes an air blowing machine, and a filter part that incorporates a filter and that is connected to the air blowing part, is characterized in that the air blower is arranged at the nape of the neck of a wearer of the protective suit.

### TECHNICAL FIELD

The present invention relates to an air blower and a protective suit including the air blower, and more particularly relates to an air blower arranged on the nape of the neck of a wearer and a protective suit in which the air blower is arranged at a position corresponding to the nape of the neck of the wearer.

### BACKGROUND

There have been conventionally known air blowers by which the interior of a protective suit is maintained in a state of pressurization or negative pressure in accordance with operational environments. For example, when the protective suit is used under the environments contaminated by asbestos, radioactive substances, or the like, the interior of the protective suit is maintained in a state of pressurization by means of an air blower including a filter, in order to prevent contaminants from intruding from cuffs or collars into the interior of the protective suit, which is attributed to the negative pressure in the protective suit due to the movement of the wearer. Alternatively, in a case where the protective suit is used in a clean room, the interior of the protective suit is maintained in a state of negative pressure by means of the air blower equipped with a filter, in order to suppress the contamination due to gas or dust generated from the human body.

As the above-mentioned air blower, for example, Patent Literature 1 discloses a protective suit in which a power source and an air blower, which is connected to the protective suit and includes an air filtering device and an air pump, are provided. The protective suit is configured to draw a draft from the air blower mounted on the outer side of the lower back portion of the protective suit into the head portion of the protective suit through an air hose.

### CITATION LIST

### Patent Literature

{PTL 1} JP 2005-2545 A

### SUMMARY

### Technical Problem

Regarding the protective suit disclosed in Patent Literature 1, the air hose is exposed to the outside of the protective suit, and in some cases, the air hose gets caught on a protrusion in a work area, which becomes an impediment to operations.

It is an object of the present invention to provide an air blower and a protective suit that includes the air blower, which eliminates an air hose that connects the air blower to the protective suit without the air hose getting caught on a protrusion in a work area and provides favorable workability.

### Solution to Problem

An air blower according to the present invention is used for a protective suit, and the air blower configured to include an air blowing part that includes an air blowing machine, and a filter part that incorporates a filter and that is connected to the air blowing part, is featured in that the air blower is arranged at the nape of the neck of a wearer of the protective suit, and the protective suit according to the present invention is configured to include the air blower at a position corresponding to the nape of the neck of the wearer.

### Advantageous Effects of Invention

The air blower of the present invention is configured to be directly arranged on the nape of the neck of the wearer of the protective suit, which eliminates an air hose that connects the air blower to the protective suit, so that there is no case for the air hose to get caught on a protrusion in a work area, thereby providing the air blower that has favorable workability and the protective suit that includes the air blower.

### BRIEF DESCRIPTION OF DRAWINGS

The drawings illustrate specific embodiments of the present invention including optional and preferred embodiments as well as essential features of the invention.

FIG. 1 is an external perspective view of an air blower according to the present invention.

FIG. 2 is an exploded perspective view of the air blower according to a first embodiment.

FIG. 3 is a schematic view illustrating a state where the air blower and a protective suit according to a first embodiment are used.

FIG. 4 is an exploded perspective view of the air blower according to a second embodiment.

### DESCRIPTION OF EMBODIMENTS

### First Embodiment

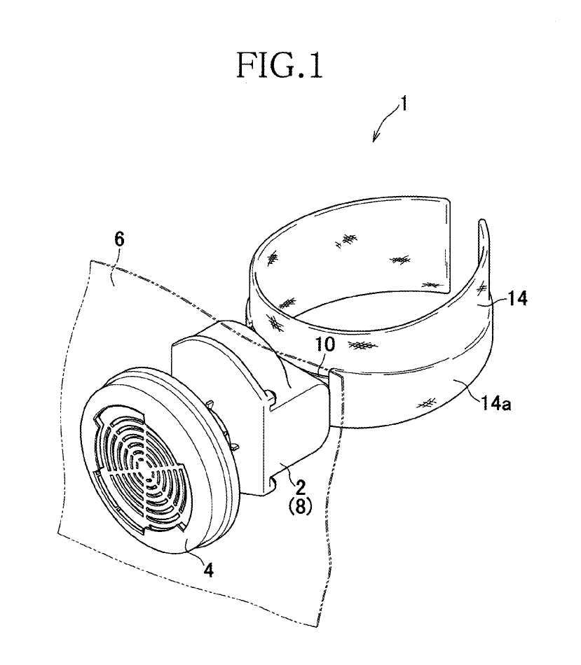

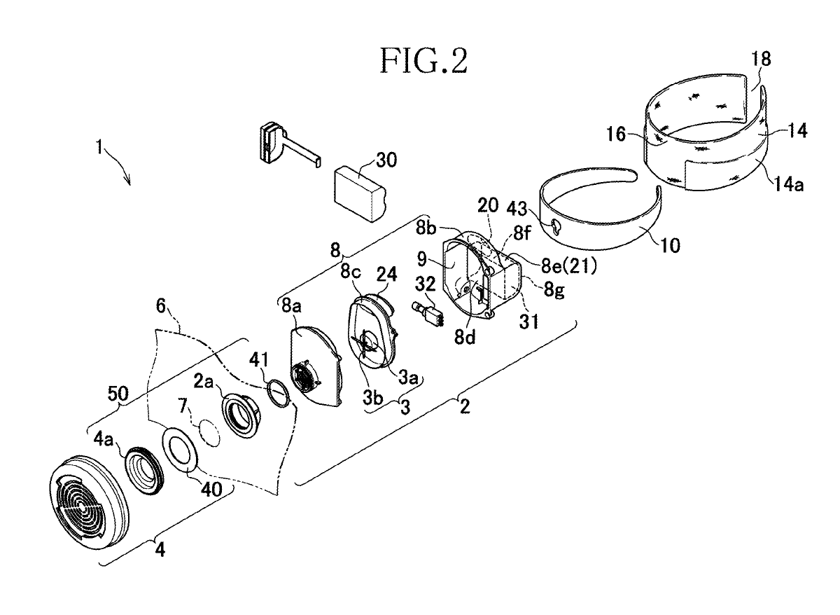

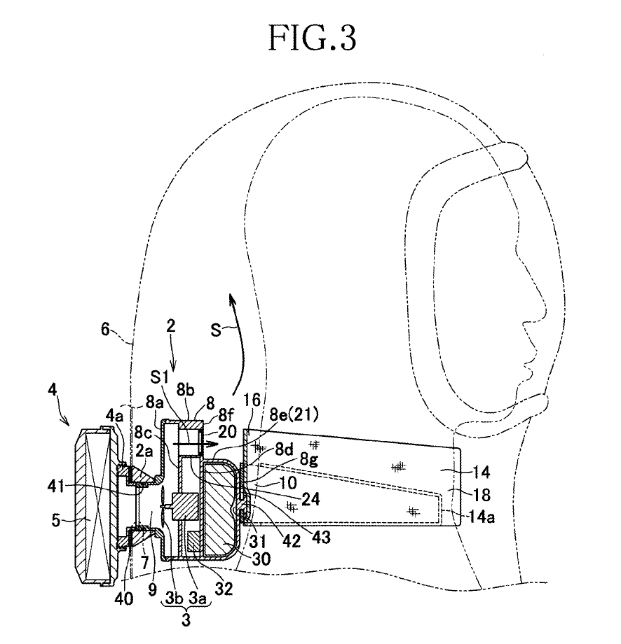

As illustrated in FIG. 1, an air blower 1 is configured to include an air blowing part 2 that includes an air blowing machine 3 and a power source 30 that are incorporated in a casing 8, a filter part 4 that incorporates a filter 5 (see FIG. 3) and is connected to the air blowing part 2, and a locking tool 10 mounted on the casing 8 of the air blowing part 2, and configured to be arranged on the nape of the neck of a wearer. The filter part 4 (see FIG. 2) that includes the filter 5, a filter-side connecting tube 4a, and a sealing member 40 is positioned on the outer side of a protective suit 6 illustrated in an imaginary line, and the air blowing part 2 is positioned on the inner side of the protective suit 6. The locking tool 10 serves to lock the air blower 1 on the neck of the wearer in the protective suit 6, and the air blower 1 is arranged on the nape of the neck of the wearer of the protective suit 6 by means of the locking tool 10. Furthermore, the locking tool 10 includes a soft sealing member 14. It is noted that although the whole image of the protective suit 6 is not illustrated in FIG. 1, the air blower 1 of the present invention can be used to an arbitrary protective suit 6.

In this embodiment, the following description is made such that the air blower 1 is used to maintain a state of pressurization in the protective suit 6, and air drawn in from the outside through the filter 5 is delivered to the interior of the protective suit 6. The air delivered in the interior of the protective suit 6 is discharged from the interior of the protective suit 6 in a state of being pressurized, through the cuffs, cloth and the like, to the outside. Accordingly, outside air contaminated can be prevented from directly intruding into the protective suit 6. It is noted that the filter part 4 may be disposable or may be one that can be repetitively used by the replacement of the filter 5. Types of filter 5 can be appropriately determined in accordance with operational purposes, and for example, canisters for removing organic gas may be used, or filtering materials for removing dust may be used.

As illustrated in FIGS. 2 and 3, the connection between the air blowing part 2 and the filter part 4 is made via a connection mechanism 50 constituted by the filter-side connecting tube 4a, a sealing member 40, an air-blowing-side connecting tube 2a, and an O-ring 41. More particularly, the filter-side connecting tube 4a extended from the filter part 4 is inserted into an opening 7 provided on a surface facing the nape of the neck of the wearer of the protective suit 6 and fitted with the air-blowing-side connecting tube 2a that is provided in the air blowing part 2 and extended in such a manner as to be oriented to the outer side of the protective suit 6, thereby connecting the air blowing part 2 with the filter part 4. The fitting of the filter-side connecting tube 4a with the air-blowing-side connecting tube 2a can be made by known means such as couplers and threaded engagement, and it is preferable that the filter-side connecting tube 4a and the air-blowing-side connecting tube 2a be repetitively detachable. Also, when the air blowing part 2 and the filter part 4 are connected, the annular sealing member 40 along with the cloth of the protective suit 6 is airtightly sandwiched between the air blowing part 2 and the filter part 4, which prevents the contaminated outside air from intruding from the opening 7 of the protective suit 6. Alternatively, it can be configured such that the protective suit is sandwiched between the filter-side connecting tube 4a and the air-blowing-side connecting tube 2a by the absorptive force of a magnetic force, thereby preventing the contaminated outside air from intruding from the opening 7 of the protective suit 6.

The air blowing part 2 is configured to include the air-blowing-side connecting tube 2a, the O-ring 41, the air blowing machine 3 made up of a motor 3a and a fan 3b that are stored in the casing 8, a switch 32 of the air blowing machine 3, and a power source 30 of the air blowing machine 3. The casing 8 includes a lid part 8a to which the air-blowing-side connecting tube 2a is attached, a main body part 8b, a partition wall 8c incorporated in the main body part 8b. The O-ring 41 is inserted between the lid part 8a and the air-blowing-side connecting tube 2a, which maintains an airtight state between the air blowing part 2 and the filter part 4. The attachment of the air-blowing-side connecting tube 2a to the lid part 8a can be made by known means such as couplers and threaded engagement, and it is preferable that the air-blowing-side connecting tube 2a and the lid part 8a be repetitively detachable. Thus, the airtightness between the air blowing part 2 and the filter part 4 and between the air blower 1 and the protective suit 6 is maintained by connecting the air blowing part 2 with the filter part 4 via the connection mechanism 50, and the filter part 4 can also be replaced as needed.

The main body part 8b includes an air blowing machine storage room 9 that stores the air blowing machine 3 mounted on the partition wall 8c and a switch 32, and a power source storage room 31 that stores the power source 30. The air blowing machine storage room 9 and the power source storage room 31 are partitioned by a partition wall 8d. The power source storage room 31 is positioned on the leeward side of the air blowing machine storage room 9 in the direction of the air blowing from the air blowing machine 3 and formed in a convex with respect to the air blowing machine storage room 9, and the power source storage room 31 includes an outer wall surface 8e orthogonal to the air blowing machine storage room 9 and extended in the direction parallel to the air blowing direction. Also, an air blowing opening 20 is provided on a wall surface part 8f of the air blowing machine storage room 9 contiguous and orthogonal to the outer wall surface 8e. In the present embodiment, the wall surface part 8f faces the lid part 8a. When the air blower 1 is used, the power source storage room 31 is interposed between the air blowing machine storage room 9 and the nape of the neck of the wearer. It is noted that the air blowing direction described in the instant application means the flowing direction S1 of airflow directed from the air blowing opening 20 to the nape of the neck of the wearer. In other words, the air blowing direction means a direction oriented from the back to the nape of the neck of the wearer and parallel to the direction approximately orthogonal to the nape of the neck of the wearer.

The main body part 8b stores the partition wall 8c, on which the air blowing machine 3 made up of the motor 3a and the fan 3b is mounted. Furthermore, an air blowing cylinder 24 for delivering the airflow from the air blowing machine 3 to the outside of the casing 8 is provided on the partition wall 8c. The air blowing cylinder 24 is extended in the direction parallel to the air blowing direction and fitted into the air blowing opening 20 provided on the wall surface part 8f of the air blowing machine storage room 9. Also, in the air blowing machine storage room 9, the switch 32 is provided between the partition wall 8c and the partition wall 8d. It is noted that the illustration of electrical wiring is omitted in the instant application.

The locking tool 10 for locking the air blower 1 on the neck of the wearer is extended from the end surface 8g of the power source storage room 31 facing the lid part 8a in the casing 8 to the leeward side of the air blowing direction while being curved in a ring shape. The locking tool 10 according to the present embodiment is formed of an annular elastic member including an open part 18 that part of the ring is open. Metal, resin, rubber, or a combination of these can be applied to the materials of the annular elastic member constituting the locking tool 10. The open part 18 is formed at a position detached from the air blowing part 2 and opposite to the air blowing part 2. When an external force is applied in the direction that the air blower 1 is separated from the wearer, the open part 18 functions as a locking release part for releasing the locking with respect to the neck of the wearer. It is noted that the specific constitution of the locking release part is not limited to the open part 18, and for example, a belt member whose part includes apiece of cloth or sheet having a low degree of breakage, which is broken when strongly pulled, or a belt member that includes a section where the intensity of a notch or the like is locally reduced can be applied.

Also, the hygroscopic soft sealing member 14 is provided on a surface facing the neck of the wearer of the locking tool 10. The hygroscopic soft sealing member 14 includes an extension part 16 that is extended to outer side of the width direction of the locking tool 10 annularly extended and that is positioned in the airflow from the air blowing part 2. Preferably, the extension part 16 faces the air blowing opening 20 and is provided at a position where the airflow from the air blowing opening 20 is directly exposed. The hygroscopic soft sealing member 14 can be formed of known materials such as a woven fabric, a nonwoven fabric, and foaming materials and preferably, materials having a cold touch on contact, having high thermal conductivity, and capable of having a high water content can be used. As an example of the materials having a cold touch on contact, the materials are exemplified by fibers made of resin in which fillers having high thermal conductivity are blended, or fibers in which both hygroscopicity and moisture releasability are improved by changing the fibrous structure of synthetic fibers, but not limited to these. The soft sealing member 14 can be fixedly adhered to the locking tool 10 and can be replaced in such a manner that the soft sealing member 14 is formed in a bag shape so as to be capable of being inserted into and removed from the locking tool 10, or that the soft sealing member 14 is temporarily adhered to the locking tool 10 by means of double-sided adhesive tapes that can be repeatedly adhered. In the present embodiment, a bag-shaped part 14a is provided in the soft sealing member 14.

In FIG. 3, a state during the use of the air blower 1 is schematically illustrated. In the present embodiment, the air blower 1 is locked on the neck of the wearer by the locking tool 10 in the protective suit 6 and mounted in such a manner that, when the wearer stands up straight, the air blowing opening 20 of the air blower 1 is positioned above the outer wall surface 8e of the casing 8. The airflow from the air blowing machine 3 incorporated in the air blower 1 is blown out from the air blowing opening 20 to the nape of the neck of the wearer. The airflow that bumps into the nape of the neck of the wearer is temporarily dispersed, and an air current oriented downward is blocked by the outer wall surface 8e of the casing 8, and the flowing direction is oriented upward. That is, in the present embodiment, the outer wall surface 8e of the casing 8 functions as a drift means 21 that deflects at least part of the flowing direction of the airflow from the air blowing opening 20 in one direction.

As described above, even when the airflow is briefly oriented downward, the flowing direction of the airflow is changed upward by the outer wall surface 8e of the casing 8, so that, as illustrated by an arrow S in FIG. 3, the flowing direction of the airflow blown out from the air blowing opening 20 is mainly oriented upward, that is, to the back of the head of the wearer. Accordingly, the back of the head of the wearer is cooled, and heat stress, which leads to an impediment to the operation of the wearer, is alleviated. It is noted that the air blower 1 is mounted in such a manner that the air blowing opening 20 of the air blower 1 is positioned below the outer wall surface 8e of the casing 8, and the air blower 1 can be used in such a manner that the back of the wearer is cooled by the airflow from the air blowing machine 3. In the present embodiment, the air blowing part 2 is rotatably mounted to the locking tool 10. That is, as illustrated in FIGS. 2 and 3, it is constituted such that a pin hole 43 that is opened in a surface facing the end surface 8g in the locking tool 10, wherein a large-diameter portion and a small-diameter portion thereof are contiguously disposed, is engaged with a pin 42 that is extended from the end surface 8g of the power source storage room 31 along the air blowing direction, wherein a head portion thereof increases in diameter. Accordingly, the position of the air blowing opening 20 with respect to the locking tool 10 can be changed as needed. In view of the alleviation of the heat stress of the wearer, it is preferable that the air blowing opening 20 of the air blower 1 be positioned above the outer wall surface 8e of the casing 8, and the air blower 1 is used. It is noted that, preferably, the air blowing cylinder 24 fitted into the air blowing opening 20 is provided in such a manner as to be oriented in the horizontal or obliquely downward direction when the wearer has an upright posture during use. This can prevent the sweat from erroneously flowing into the casing 8 through the air blowing cylinder 24.

Also, the hygroscopic soft sealing member 14 provided on the surface facing the neck of the wearer of the locking tool 10 not only can function as a cushion contacted with the neck of the wearer during the use of the air blower 1, but also can absorb the sweat. Herein, the extension part 16 of the hygroscopic soft sealing member 14 is positioned within the airflow from the air blowing part 2, so that the temperature of the soft sealing member 14 can be reduced by latent heat in a case where the moisture of the sweat absorbed by the soft sealing member 14 vaporizes by the airflow, thereby further alleviating the heat stress of the wearer. As described above, it is preferable that the materials having a cold touch on contact be applied to the soft sealing member 14.

### Second Embodiment

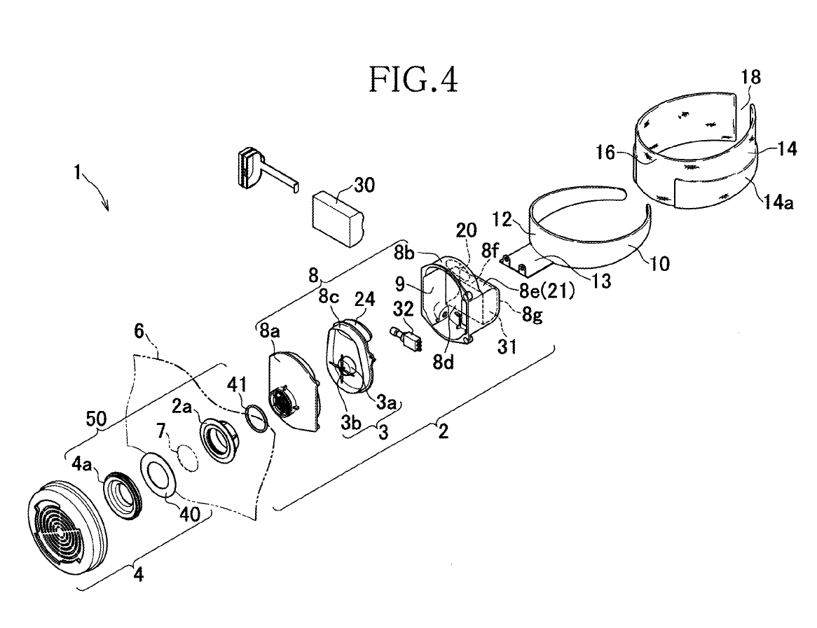

As illustrated in FIG. 4, in the present embodiment, an extension part 13 of the locking tool 10 is used in place of the outer wall surface 8e of the casing 8, as the drift means 21 that deflects at least part of the flowing direction of the airflow from the air blowing opening 20 in one direction. In the description below, it is assumed that the air blower 1 does not include the power source storage room 31, and the power source 30 and the switch 32 are provided as a power source box separated from the air blower 1 and put in a pocket of a wearer of the protective suit 6 when the protective suit 6 is used.

The air blower 1 of the present embodiment is configured to include the air blowing part 2 that includes the air blowing machine 3 incorporated in the casing 8, the filter part 4 that incorporates the filter 5 and is connected to the air blowing part 2, and the locking tool 10 mounted on the casing 8 of the air blowing part 2, and configured to be arranged on the nape of the neck of a wearer. The constitution of the filter part 4, the air blowing machine 3 made up of the motor 3a and the fan 3b, and the connection mechanism of the air blowing part 2 and the filter part 4 are similar to those of the first embodiment, and accordingly their detailed descriptions are omitted.

The casing 8 of the present embodiment includes the lid part 8a to which the air-blowing-side connecting tube 2a is airtightly and detachably mounted, the partition wall 8c, and the main body part 8b. The air blowing opening 20 is provided on the wall surface part 8f of the main body part 8b facing the lid part 8a. The air blowing machine 3 is mounted on the partition wall 8c and stored in the main body part 8b. Furthermore, the air blowing cylinder 24 for delivering the airflow from the air blowing machine 3 to the outside of the casing 8 is provided on the partition wall 8c. The air blowing cylinder 24 is extended in the direction parallel to the air blowing direction and fitted into the air blowing opening 20 provided on the wall surface part 8f of the main body part 8b.

As is the same with the first embodiment, the locking tool 10 for locking the air blower 1 on the neck of the wearer is constituted of an annular elastic member including the open part 18 (the locking release part) that part of the ring is open, and further includes an opposite area 12 opposite to the air blowing part 2 and includes the extension part 13 extended from the opposite area 12 to the wall surface part 8f of the casing 8 constituting the air blowing part 2 and interposed between the air blowing opening 20 and the opposite area 12. The extension part 13 is formed in a planar shape, and preferably, the width thereof is approximately equal to that of the casing 8, and the extension part 13 can be formed integrally with or separately from the locking tool 10. In the present embodiment, the mounting section of the extension part 13 to the wall surface part 8f is provided at a position at which the extension part 13 does not interfere with the air blowing opening 20 of the wall surface part 8f.

As is the same with the first embodiment, the air blower 1 according to the present embodiment is locked on the neck of the wearer by means of the locking tool 10, and when the wearer stands up straight, the air blowing opening 20 of the air blower 1 is mounted in such a manner as to be positioned above the extension part 13 of the locking tool 10, and the airflow from the air blowing machine 3 is blown out from the air blowing opening 20 to the nape of the neck of the wearer. The airflow that bumps into the nape of the neck of the wearer is temporarily dispersed, and an air current oriented downward is blocked by the extension part 13 of the locking tool 10, and the flowing direction is oriented upward. That is, in the present embodiment, the extension part 13 of the locking tool 10 functions as the drift means 21 that deflects at least part of the flowing direction of the airflow from the air blowing opening 20 in one direction.

As described above, even when the airflow is briefly oriented downward, the flowing direction of the airflow is changed upward by the extension part 13 of the locking tool 10, as is the same with the first embodiment, so that the flowing direction of the airflow blown out from the air blowing opening 20 is mainly oriented upward, that is, to the back of the head of the wearer. Accordingly, the back of the head of the wearer is cooled, and heat stress, which leads to an impediment to the operation of the wearer, is alleviated. It is noted that the locking tool 10 of the air blower 1 according to the present embodiment also includes the hygroscopic soft sealing member 14. However, the constitution of the hygroscopic soft sealing member 14 is similar to that of the first embodiment, and its detailed description is omitted.

Thus, the air blower 1 according to the second embodiment has been described as one that does not include the power source storage room 31. However, the present embodiment is not limited to this, but the power source storage room 31 may be provided, for example, on the bilateral sides or the bottom side of the casing 8. Also, the second embodiment has been described as one wherein the air blowing machine 3 is mounted on the partition wall 8c, and the air blowing cylinder 24 is provided. However, it may be configured such that the air blowing machine 3 is directly mounted on the inner wall of the main body part 8b of the casing 8 without using the partition wall 8c and the air blowing cylinder 24, and an opening part is provided on the wall surface part 8f of the main body part 8b facing the lid part 8a, thereby blowing the air to the opposite area 12 of the locking tool 10.

The present invention has been described based on the first and second embodiments. However, the present invention is not limited to these embodiments, but can be applied in the form of various modifications. For example, the position at which the annular locking tool 10 is mounted on the air blower 1 is arbitrary, and for example, the locking tool 10 can be mounted on the lateral wall or the bottom surface of the main body part 8b of the casing 8 and can be mounted on the lateral portion of the lid part 8a. Also, the locking tool 10 for locking the air blower 1 on the neck of the wearer can be constituted of a belt that fastens both shoulders in the protective suit 6, or it can be constituted such that the air blower 1 is suspended from an annular or hat-shaped member that covers the head of the wearer. Also, structure can be applied wherein the air blowing machine 3 is positioned at the nape of the neck of the wearer on the outside of the protective suit 6, and the air blowing opening 20 is positioned in the protective suit 6, or structure can be applied wherein the whole of the air blower 1 is positioned in the protective suit 6, and only the air intake surface of the filter part 4 is exposed to the back surface of the protective suit 6. Also, as another example, a pocket is formed at a section corresponding to the nape of the neck of the protective suit 6, and the air blower 1 can be arranged in the pocket. Furthermore, the embodiments have been described based on the example in which the flowing direction of the airflow blown out from the air blowing opening 20 is oriented upward, that is, to the back of the head of the wearer, but the flowing direction of the airflow can be oriented downward, that is, to the back of the wearer. Also, the example of the case where the connection mechanism 50 that connects the air blowing part 2 with the filter part 4 includes the O-ring 41 has been described, but when the interior of the protective suit 6 is maintained in positive pressure, the O-ring 41 can be omitted.

The disclosure regarding the air blower of the present invention described above can be arranged at least in the following features.

The air blower is used for a protective suit, and the air blower configured to include an air blowing part that includes an air blowing machine, and a filter part that incorporates a filter and that is connected to the air blowing part, is featured in that the air blower is arranged at a nape of a neck of a wearer of the protective suit.

The above-mentioned present invention includes at least embodiments described below, and the embodiments are adopted by separating from each other or by combining with each other.

(1) Furthermore, the air blower includes a locking tool configured to lock the air blower on the neck of the wearer in the protective suit.

(2) The locking tool is extended on a circumference of the neck of the wearer, and the air blower is provided on the neck of the wearer in a lockable manner.

(3) The air blowing machine is configured to blow air from an air blowing opening, which is arranged in such a manner as to be detached from the nape of the neck of the wearer, to the nape of the neck of the wearer, and configured to include adrift means that is interposed between the air blowing opening and the nape of the neck of the wearer and that deflects at least part of a flowing direction of airflow from the air blowing opening in one direction.

(4) The air blower is configured to include a power source storage room that stores a power source of the air blowing machine and include an opposite area where the locking tool faces the air blowing part, and the power source storage room is interposed between the air blowing opening and the opposite area, and an outer wall surface of the power source storage room positioned between the air blowing opening and the opposite area deflects at least part of the flowing direction of the airflow from the air blowing opening in one direction.

(5) The locking tool is configured to include an opposite area opposite to the air blowing part and include an extension part that is extended from the opposite area to the air blowing part and interposed between the air blowing opening and the opposite area, and the extension part deflects at least part of the flowing direction of the airflow from the air blowing opening in one direction.

(6) The locking tool is configured to include a hygroscopic soft sealing member facing the neck of the wearer.

(7) The soft sealing member is configured to include an extension part that is extended to an outer side of the locking tool and positioned in the airflow from the air blowing part.

(8) The locking tool is configured to include a locking release part that, when an external force is applied in a direction that the air blower is separated from the wearer, releases the locking.

The disclosure regarding the protective suit of the present invention described above can be arranged at least in the following matters.

A protective suit is configured to include an air blower arranged at a position corresponding to the nape of the neck of a wearer, and featured in that the air blower is configured to include an air blowing part that includes an air blowing machine, and a filter part that incorporates a filter and that is connected to the air blowing part.

The above-mentioned present invention includes at least embodiments described below, and the embodiments are adopted by separating from each other or by combining with each other.

(1) Furthermore, the air blower includes a locking tool configured to lock the air blower on the neck of the wearer in the protective suit.

(2) The locking tool is extended on a circumference of the neck of the wearer, and the air blower is provided on the neck of the wearer in a lockable manner.

(3) The air blowing machine is configured to blow air from an air blowing opening, which is arranged in such a manner as to be detached from the nape of the neck of the wearer, to the nape of the neck of the wearer, and configured to include adrift means that is interposed between the air blowing opening and the nape of the neck of the wearer and that deflects at least part of a flowing direction of airflow from the air blowing opening in one direction.

(4) The air blower is configured to include a power source storage room that stores a power source of the air blowing machine and include an opposite area where the locking tool faces the air blowing part, and the power source storage room is interposed between the air blowing opening and the opposite area, and an outer wall surface of the power source storage room positioned between the air blowing opening and the opposite area deflects at least part of the flowing direction of the airflow from the air blowing opening in one direction.

(5) The locking tool is configured to include an opposite area opposite to the air blowing part and include an extension part that is extended from the opposite area to the air blowing part and interposed between the air blowing opening and the opposite area, and the extension part deflects at least part of the flowing direction of the airflow from the air blowing opening in one direction.

(6) The locking tool is configured to include a hygroscopic soft sealing member facing the neck of the wearer.

(7) The soft sealing member is configured to include an extension part that is extended to an outer side of the locking tool and positioned in the airflow from the air blowing part.

(8) The locking tool is configured to include a locking release part that, when an external force is applied in a direction that the air blower is separated from the wearer, releases the locking.

### REFERENCE SIGNS LIST

1 air blower
2 air blowing part
3 air blowing machine
4 filter part
5 filter
6 protective suit
7 opening
8 casing
8e outer wall surface
8f wall surface part
9 air blowing machine storage room
10 locking tool
12 opposite area
13 extension part
14 soft sealing member
16 extension part
18 open part (locking release part)
20 air blowing opening
21 drift means
30 power source
31 power source storage room
s airflow

1. An air blower for a protective suit, the air blower configured to include an air blowing part that includes an air blowing machine, and a filter part that incorporates a filter and that is connected to the air blowing part and configured to be arranged at a nape of a neck of a wearer, comprising:
a locking tool configured to be extended on a circumference of the neck of the wearer in the protective suit and configured to lock the air blower on the neck of the wearer,
wherein the locking tool is configured to be made up of an annular elastic member including an open part that part of a ring is open.

2-3. (canceled)

4. The air blower according to claim 1,
wherein the air blowing machine is configured to blow air from an air blowing opening, which is arranged in such a manner as to be detached from the nape of the neck of the wearer, to the nape of the neck of the wearer, and configured to include a drift means that is interposed between the air blowing opening and the nape of the neck of the wearer and that deflects at least part of a flowing direction of airflow from the air blowing opening in one direction.

5. The air blower according to claim 4,
wherein the air blower is configured to include a power source storage room that stores a power source of the air blowing machine and include an opposite area where the locking tool faces the air blowing part, and the power source storage room is interposed between the air blowing opening and the opposite area, and an outer wall surface of the power source storage room positioned between the air blowing opening and the opposite area deflects at least part of the flowing direction of the airflow from the air blowing opening in one direction.

6. The air blower according to claim 4,
wherein the locking tool is configured to include an opposite area opposite to the air blowing part and include an extension part that is extended from the opposite area to the air blowing part and interposed between the air blowing opening and the opposite area, and
wherein the extension part deflects at least part of the flowing direction of the airflow from the air blowing opening in one direction.

7. The air blower according to claim 4,
wherein the locking tool is configured to include a hygroscopic soft sealing member facing the neck of the wearer.

8. The air blower according to claim 7,
wherein the soft sealing member is configured to include an extension part that is extended to an outer side of the locking tool and positioned in the airflow from the air blowing part.

9. (canceled)

10. A protective suit comprising:
the air blower according to claim 1 arranged at a position corresponding to the nape of the neck of the wearer.
